(19) United States
(12) Patent Application Publication
(10) Pub. No.: US 2015/0164000 A1
(43) Pub. Date: Jun. 18, 2015

(54) Picking Device for Maize or the Like

(71) Applicant: Franz SCHRATTENECKER, Eggerding (AT)

(72) Inventor: Franz Schrattenecker, Eggerding (AT)

(21) Appl. No.: 14/357,664

(22) PCT Filed: Nov. 12, 2012
(86) PCT No.: PCT/EP2012/004699

§ 371 Date: Sep. 15, 2014

(30) Foreign Application Priority Data
Nov. 11, 2011 (DE) 10 2011 118 322.5

(51) Int. Cl. A01D 45/02; A01D 57/01; A01D 34/73

(52) U.S. Cl. CPC A01D 45/02; A01D 45/028; A01D 34/73; A01D 57/01

(57) ABSTRACT

A picking device for corn or the like comprises several picking units (1) which each comprise a picking gap (7) and rotating cutting knives (2, 3, 4). To improve the chopping effect, the picking units (1) comprise several rotating cutting knives (2, 3, 4) which are vertically spaced and whose centrifugal circles are different from each other (FIG. 1).

The invention relates to a picking device for corn or the like and a combine-harvester with such picking device.

A picking device for corn or the like is known from DE 20 2005 003 236 U1. The picking device comprises several picking units which are arranged one beside the other and which each comprise a picking gap and a cutting knife which rotates about a substantially horizontal axis.

It is the object of the invention to improve the chopping effect in a picking device of the type mentioned above.

According to the invention, this object is solved by the features of claim 1. The picking units comprise several rotating cutting knives which are vertically spaced and whose centrifugal circles are different from each other. The chopping quality can be improved thereby.

Centrifugal circle of the cutting knives is understood to be the circle described by the outer ends of the cutting knives around the axis of rotation.

Advantageous developments are described in the sub-claims.

Advantageously, the axes of rotation of the cutting knives correspond with each other. The cutting knives can be attached to the same axle.

According to another advantageous development, the diameters of the centrifugal circles of the cutting knives are different. This is advantageous in particular when the axes of rotation of the cutting knives correspond with each other.

According to another advantageous development, the diameters of the centrifugal circles of the cutting knives decrease from bottom to top. The plants thereby initially are cut off by the bottommost knife and subsequently are comminuted by the knife or knives located above the same.

Another advantageous development is characterized in that the picking units include stationary counter-knives which are vertically spaced and which protrude into the centrifugal circles of the rotating cutting knives. The chopping effect can further be improved thereby.

According to another advantageous development, the picking units comprise a second group of cutting knives which are vertically spaced and whose centrifugal circles are different from each other.

Advantageously, the axes of rotation of the cutting knives of the second group correspond with each other and/or the diameters of the centrifugal circles of the cutting knives of the second group are different and/or the diameters of the centrifugal circles of the cutting knives of the second group decrease from bottom to top.

Another advantageous development is characterized in that the centrifugal circles of the cutting knives of the first group and the centrifugal circles of the cutting knives of the second group overlap each other.

The cutting knives of the first group and the cutting knives of the second group can rotate in the same direction. It is, however, also possible that the cutting knives of the first group and the cutting knives of the second group rotate in opposite directions.

Another advantageous development is characterized in that the rotating cutting knives are arranged on a knife carrier which is pivotally mounted on a housing part of the picking unit. It thereby is possible to vary the row distance between adjacent picking units.

Advantageously, the picking unit includes two knife carriers which are pivotable to each other in opposite directions. Advantageously, the knife carriers are pivotable to each other to the same extent.

The invention furthermore relates to a combine-harvester which is characterized by a picking device according to the invention.

Exemplary embodiments of the invention will be explained in detail below with reference to the attached drawing, in which:

FIG. 1 shows a picking device for corn in a side view,

FIG. 2 shows a picking unit of the picking device according to FIG. 1 in a view from above,

FIG. 3 shows a further picking unit with two groups of cutting knives, which rotate in opposite directions, in a view from above,

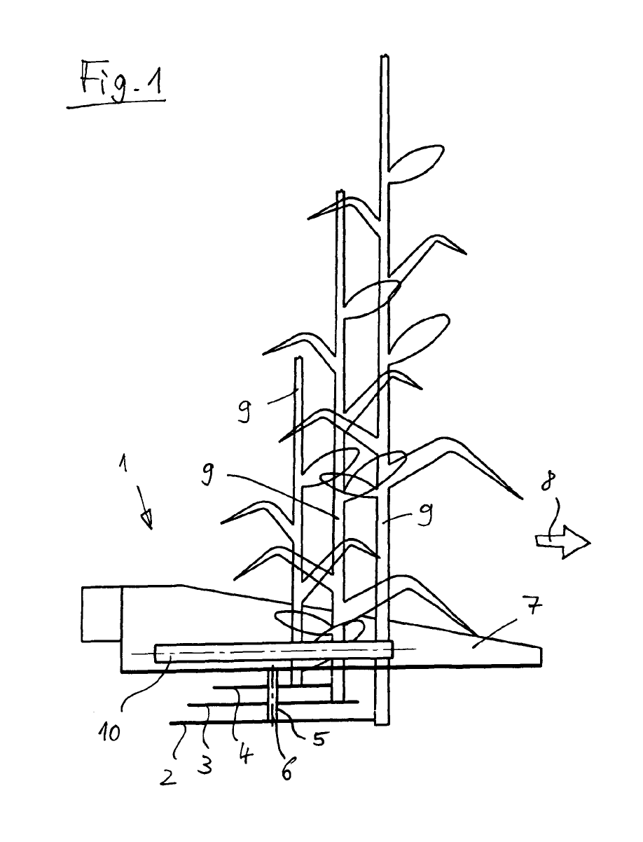

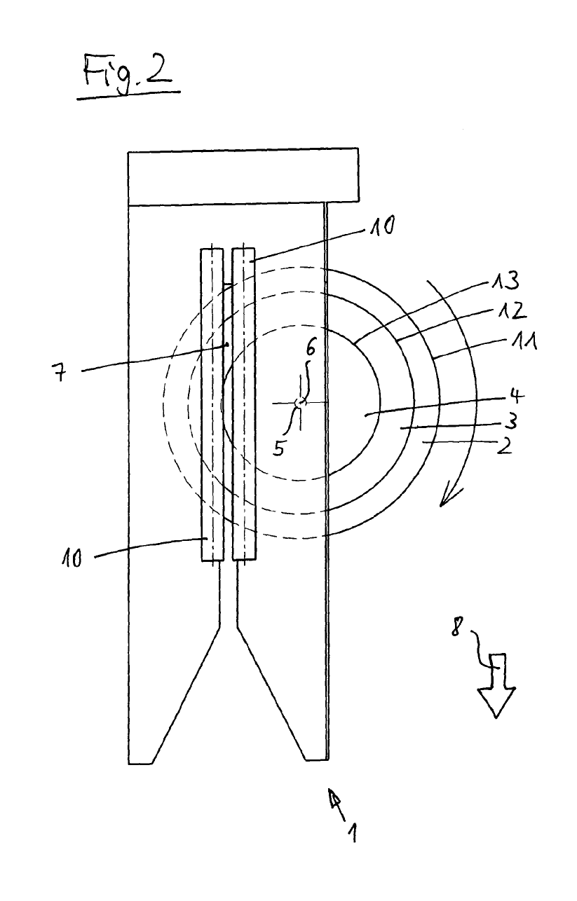

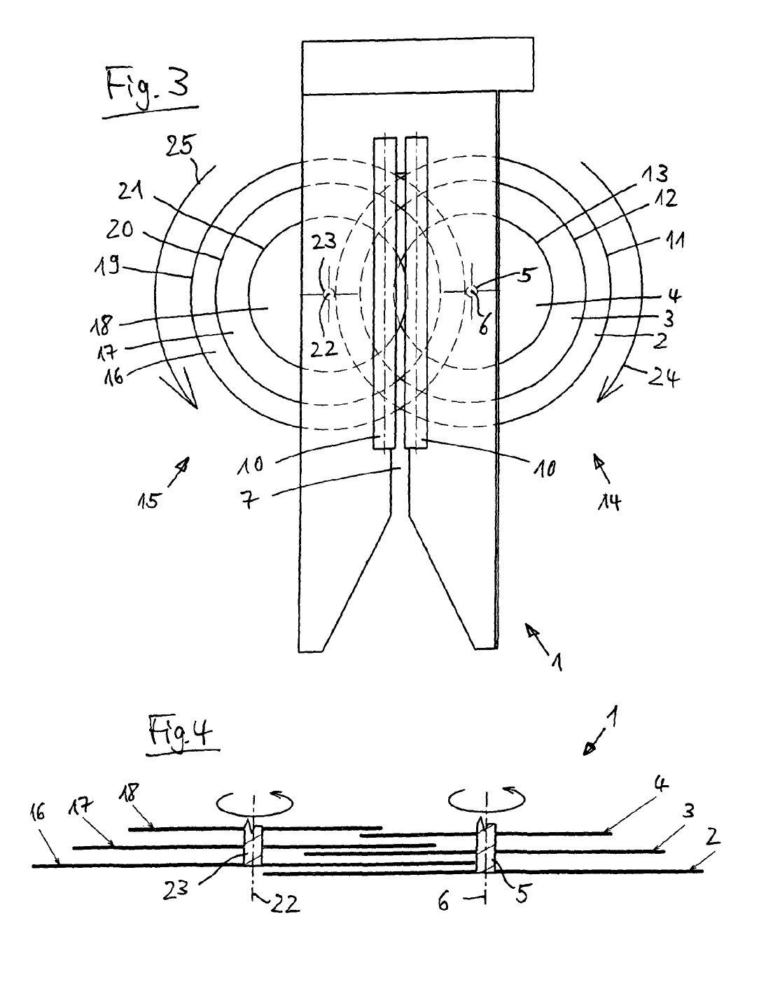

FIG. 4 shows the cutting knives of the picking unit according to FIG. 3 in a side view,

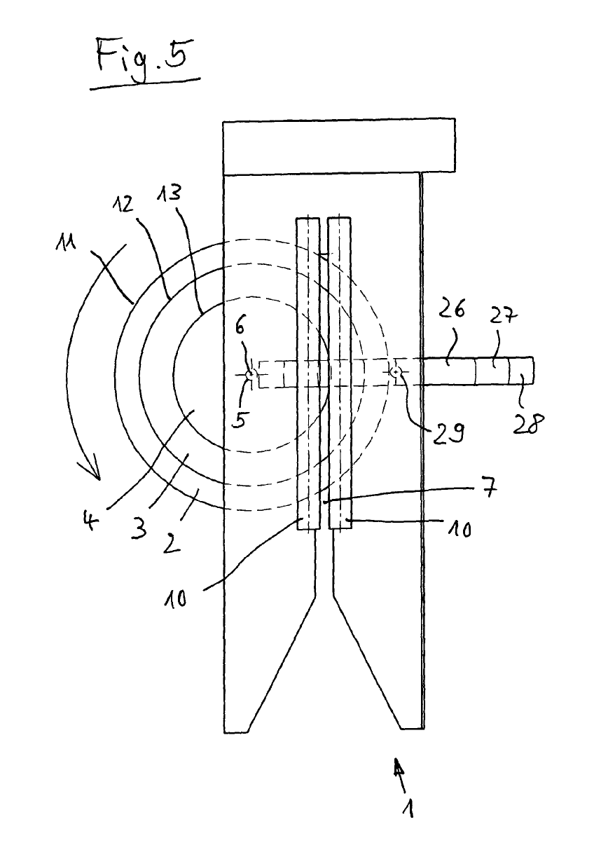

FIG. 5 shows a further picking unit with stationary counter-knives in a view from above,

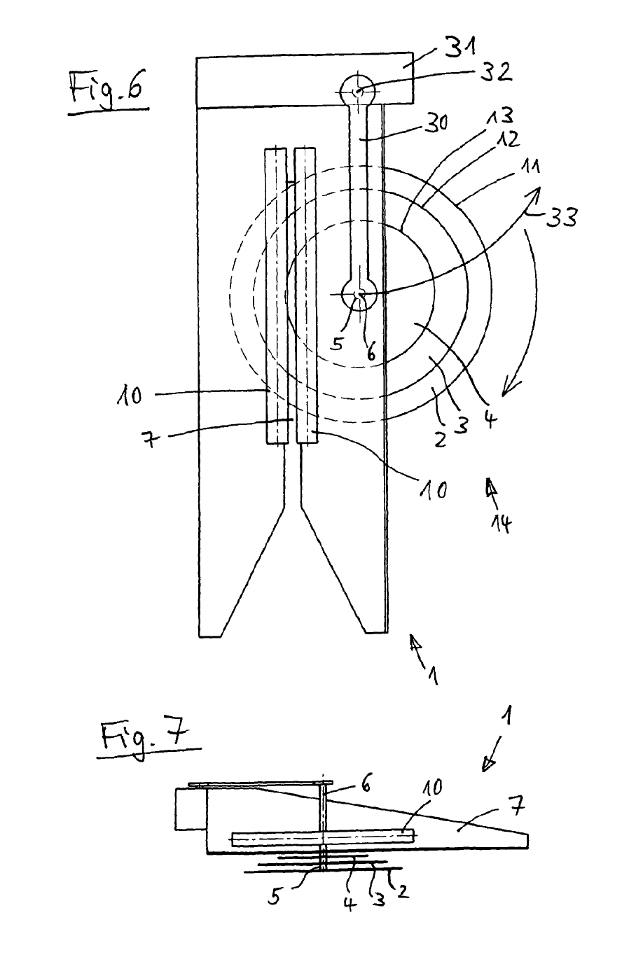

FIG. 6 shows a further picking unit in which the cutting knives are arranged on a pivotally mounted knife carrier in a view from above,

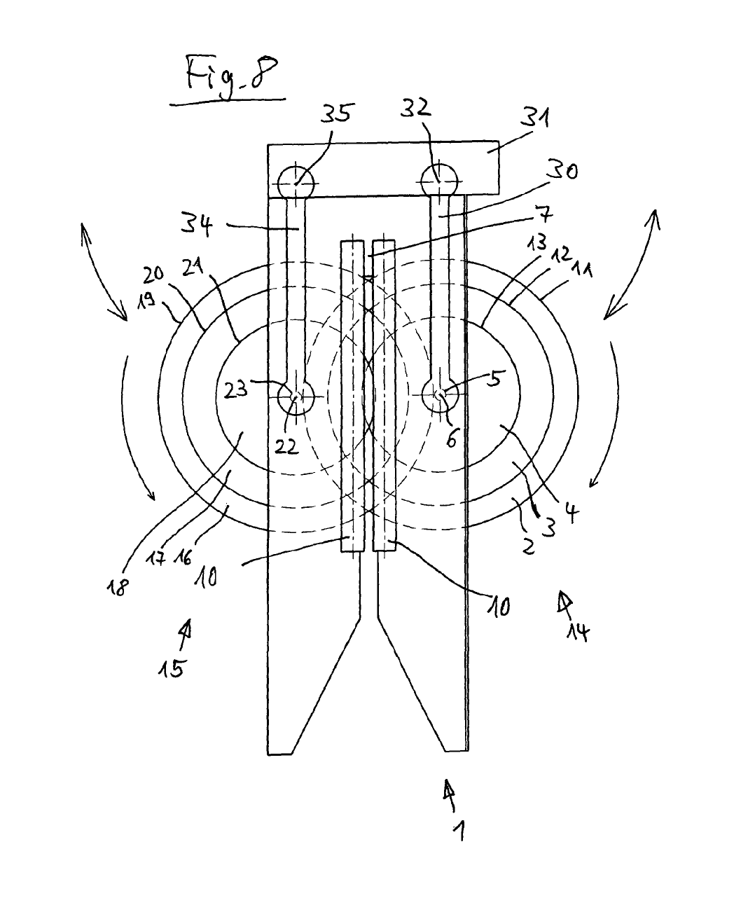

FIG. 7 shows the cutting knives of the picking unit according to FIG. 3 in a side view,

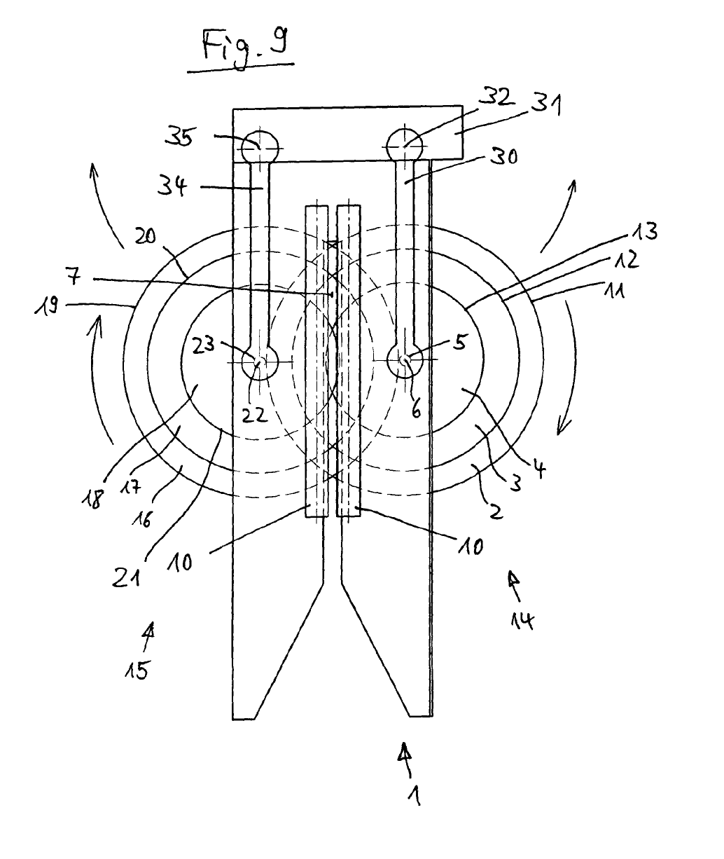

FIG. 8 shows a further picking unit with two knife carriers which are pivotable to each other in opposite directions and with two groups of cutting knives which rotate in opposite directions in a view from above,

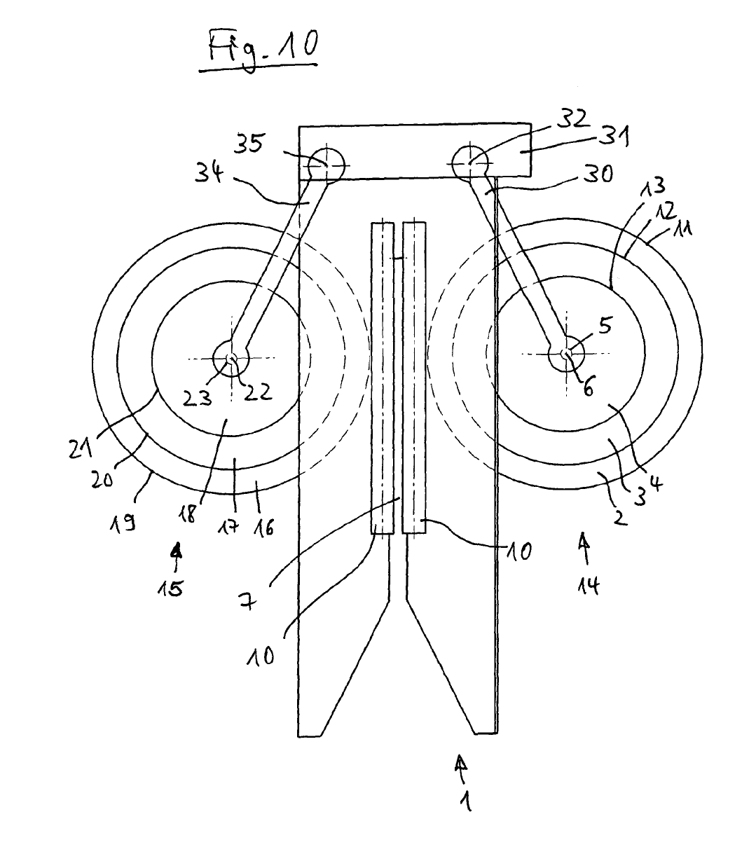

FIG. 9 shows the picking unit according to FIG. 8, in which the groups of cutting knives rotate in opposite directions, in a view from above, and

FIG. 10 shows the picking unit according to FIGS. 8 and 9 with pivoted knife carriers.

The picking device shown in FIG. 1 comprises several picking units 1 which can be mounted on a combine-harvester (not shown in the drawing). The picking units 1 each comprise several, namely three cutting knives 2, 3, 4 which are attached to a vertical axle 5 and rotate about a vertical rotation axis 6. The picking units 1 furthermore each comprise a picking gap 7 which extends in the working direction 8 of the picking device. The working direction 8 is the direction of travel of the combine-harvester to which the picking device is attached. When the picking device moves in working direction 8, corn plants 9 grown from the ground get into the picking gap. They are cut off there by the cutting knives 2, 3, 4 and comminuted.

FIG. 2 shows a picking unit 1 of the picking device according to FIG. 1 in a view from above. The picking device comprises several picking units 1 which are arranged one beside the other and parallel to each other (not shown in the drawing).

As shown in FIG. 2, the picking unit 1 comprises two draw-in rollers 10 which are arranged on both sides of the picking gap 7. The draw-in rollers 10 extend in horizontal direction parallel to the working direction 8. They rotate in opposite directions.

The axle 5 of the cutting knives 2, 3, 4 is arranged at a lateral distance from the associated picking gap 7. The centrifugal circles 11, 12, 13 of the cutting knives 2, 3, 4 are different from each other. They at least partly sweep over the associate picking gap 7.

The rotation axes 6 of the cutting knives 2, 3, 4 correspond with each other. Thus, each cutting knife 2, 3, 4 has the same rotation axis 6.

Furthermore, the diameters of the centrifugal circles 11, 12, 13 of the cutting knives 2, 3, 4 are different. The diameters of the centrifugal circles 11, 12, 13 of the cutting knives 2, 3, 4 decrease from bottom to top. The bottommost knife 2 thus has the greatest centrifugal circle 11, the next upper cutting knife 3 has the next smaller centrifugal circle 12, and the uppermost cutting knife 4 has the smallest centrifugal circle 13.

FIGS. 3 and 4 show an embodiment in which the picking unit 1 comprises a first group 14 of cutting knives 2, 3, 4 and a second group 15 of cutting knives 16, 17, 18. The cutting knives 16, 17, 18 are vertically spaced. The centrifugal circles 19, 20, 21 of the cutting knives 16, 17, 18 are different from each other. The rotation axes 22 of the cutting knives 16, 17, 18 correspond with each other. The diameters of the centrifugal circles 19, 20, 21 of the cutting knives 16, 17, 18 are different. The diameters of the centrifugal circles 19, 20, 21 of the cutting knives 16, 17, 18 decrease from bottom to top. The cutting knives 16, 17, 18 are mounted on the same axle 23.

The centrifugal circles 11, 12, 13 of the cutting knives 2, 3, 4 of the first group 14 and the centrifugal circles 19, 20, 21 of the cutting knives 16, 17, 18 of the second group 15 overlap each other. As shown in FIG. 4, the planes of the cutting knives 2, 3, 4 of the first group 14 and the planes of the cutting knives 16, 17, 18 of the second group 15 are offset to each other in height. A risk of collision thereby is excluded, and the cutting effect and the chopping effect are improved.

The knives 2, 3, 4 of the first group 14 rotate in clockwise direction in a direction 24. The knives 16, 17, 18 of the second group 15 rotate in anti-clockwise direction in a direction 25. The cutting knives of the first group 14 and the cutting knives of the second group 15 thus rotate in opposite directions. It would, however, also be possible for the cutting knives of the first group 14 and the cutting knives of the second group 15 to rotate in the same direction.

FIG. 5 shows a picking unit 1 in which only one group of cutting knives 2, 3, 4 is present, like in the embodiment according to FIG. 2. The picking unit 1 according to FIG. 5 includes stationary counter-knives 26, 27, 28, which are vertically spaced and which protrude into the centrifugal circles 11, 12, 13 of the rotating cutting knives 2, 3, 4. The counter-knives 26, 27, 28 are attached to the bolt 29. They can be rotatable about the bolt 29 and be lockable. The bottommost counter-knife 26 protrudes furthest into the centrifugal circles 11, 12, 13. The next upper counter-knife 27 protrudes less into the centrifugal circles 11, 12, 13. The uppermost counter-knife 28 protrudes the least into the centrifugal circles 11, 12, 13.

The planes of the counter-knives 26, 27, 28 are offset in height to the planes of the cutting knives 2, 3, 4, similar to the cutting knives of the embodiment according to FIGS. 3 and 4.

FIGS. 6 and 7 show a further picking unit 1, in which the rotating cutting knives 2, 3, 4 are arranged on a knife carrier 30, which is pivotally mounted on a housing part 31 of the picking unit 1 about a vertical axis 32.

It thereby is possible to swivel the first group 14 of cutting knives 2, 3, 4 away from the picking gap 7, as indicated by the arrow 33.

In the embodiment according to FIG. 8, the picking unit 1 includes two knife carriers 30, 34 which are pivotally mounted on the housing part 31 about vertical axes 32, 35. The knife carriers 30, 34 are pivotable to each other in opposite directions. In the embodiment according to FIG. 8, the knives 2, 3, 4 of the first group 14 and the cutting knives 16, 17, 18 of the second group 15 rotate in opposite directions.

FIG. 9 shows the embodiment according to FIG. 8, in which the cutting knives 2, 3, 4 of the first group 14 and the cutting knives 16, 17, 18 of the second group 15 rotate in the same direction.

FIG. 10 shows the picking units 1 of FIGS. 8 and 9 with the knife carriers 30, 34 swiveled out. The knife carriers 30, 34 are swiveled to each other in opposite directions and each swiveled from each other by the same angle.

The invention creates a horizontal chopper with at least two rows of knives, wherein different centrifugal circles lead to a better chopping quality. There can be provided two horizontal choppers (FIGS. 3, 4, 8, 9, 10) which are arranged opposite each other and whose centrifugal circles overlap each other in the operating condition. Each horizontal chopper can consist of one or more knife rows arranged in parallel one above the other, wherein different centrifugal circle diameters also can overlap and wherein the smallest diameter can extend parallel to the draw-in rollers. Furthermore, it is possible that the centrifugal circles of the horizontal chopper rotate against the opposed stationary counter-knives (FIG. 5).

1. A picking device for corn or the like with several picking units (1) which each comprise a picking gap (7) and rotating cutting knives (2, 3, 4), wherein the picking units (1) comprise several rotating cutting knives (2, 3, 4) which are vertically spaced and whose centrifugal circles (12, 13, 14) are different from each other.

2. The picking device according to claim 1, wherein the rotation axes (6) of the cutting knives (2, 3, 4) correspond with each other.

3. The picking device according to claim 1, wherein the diameters of the centrifugal circles (11, 12, 13) of the cutting knives (2, 3, 4) are different.

4. The picking device according to claim 1, wherein the diameters of the centrifugal circles (11, 12, 13) of the cutting knives (2, 3, 4) decrease from bottom to top.

5. The picking device according to claim 1, wherein the picking units (1) include stationary counter-knives (26, 27, 28), which are vertically spaced and which protrude into the centrifugal circles (11, 12, 13) of the rotating cutting knives (2, 3, 4).

6. The picking device according to claim 1, wherein the picking units (1) comprise a second group (15) of cutting knives (16, 17, 18) which are vertically spaced and whose centrifugal circles (19, 20, 21) are different from each other.

7. The picking device according to claim 6, wherein the rotation axes (22) of the cutting knives (16, 17, 18) of the second group (15) correspond with each other and/or the diameters of the centrifugal circles (19, 20, 21) of the cutting knives (16, 17, 18) of the second group (15) are different and/or the diameters of the centrifugal circles (19, 20, 21) of the cutting knives (16, 17, 18) of the second group (15) decrease from bottom to top.

8. The picking device according to claim 6, wherein the centrifugal circles (11, 12, 13) of the cutting knives (2, 3, 4) of the first group (14) and the centrifugal circles (19, 20, 21) of the cutting knives (16, 17, 18) of the second group (15) overlap each other.

9. The picking device according to claim 6, wherein the cutting knives (2, 3, 4) of the first group (14) and the cutting knives (16, 17, 18) of the second group (15) rotate in the same direction or in opposite directions (24, 25).

10. The picking device according to claim 1, wherein the rotating cutting knives (2, 3, 4) are arranged on a knife carrier (30) which is pivotally (32) mounted on a housing part (31) of the picking unit (1).

11. The picking device according to claim 10, wherein the picking unit (1) includes two knife carriers (30, 34) which are pivotable (32, 35) to each other in opposite directions.

12. A combine-harvester, comprising a picking device according to claim 1.

13. The picking device according to claim 2, wherein the diameters of the centrifugal circles (11, 12, 13) of the cutting knives (2, 3, 4) are different.

14. The picking device according to claim 13, wherein the diameters of the centrifugal circles (11, 12, 13) of the cutting knives (2, 3, 4) decrease from bottom to top.

15. The picking device according to claim 3, wherein the diameters of the centrifugal circles (11, 12, 13) of the cutting knives (2, 3, 4) decrease from bottom to top.

16. The picking device according to claim 2, wherein the diameters of the centrifugal circles (11, 12, 13) of the cutting knives (2, 3, 4) decrease from bottom to top.

17. The picking device according to claim 16, wherein the picking units (1) include stationary counter-knives (26, 27, 28), which are vertically spaced and which protrude into the centrifugal circles (11, 12, 13) of the rotating cutting knives (2, 3, 4).

18. The picking device according to claim 15, wherein the picking units (1) include stationary counter-knives (26, 27, 28), which are vertically spaced and which protrude into the centrifugal circles (11, 12, 13) of the rotating cutting knives (2, 3, 4).

19. The picking device according to claim 14, wherein the picking units (1) include stationary counter-knives (26, 27, 28), which are vertically spaced and which protrude into the centrifugal circles (11, 12, 13) of the rotating cutting knives (2, 3, 4).

20. The picking device according to claim 13, wherein the picking units (1) include stationary counter-knives (26, 27, 28), which are vertically spaced and which protrude into the centrifugal circles (11, 12, 13) of the rotating cutting knives (2, 3, 4).
